(19) United States
(12) Patent Application Publication
(10) Pub. No.: US 2026/0128017 A1
(43) Pub. Date: May 7, 2026

(54) DISPLAY CORRECTION APPARATUS, DISPLAY CORRECTION METHOD, AND RECORDING MEDIUM

(71) Applicant: NEC Corporation, Tokyo (JP)

(72) Inventors: Hirohisa YAMAMOTO, Tokyo (JP); Hiroki SUGEGAYA, Tokyo (JP); Takashi ISHIBE, Tokyo (JP)

(73) Assignee: NEC Corporation, Tokyo (JP)

(21) Appl. No.: 19/323,083

(22) Filed: Sep. 9, 2025

(30) Foreign Application Priority Data
Sep. 27, 2024 (JP) 2024-168031

(51) Int. Cl. G09G 5/12; G06F 3/14; G09G 3/20

(52) U.S. Cl. CPC G09G 5/12; G06F 3/1446; G09G 3/2003; G09G 2300/026; G09G 2320/0613; G09G 2320/0646; G09G 2320/0666; G09G 2356/00; G09G 2360/04; G09G 2370/16

(57) ABSTRACT

A display correction apparatus includes one or more memories storing instructions and one or more processors configured to execute the instructions to: acquire an image obtained by imaging a display device in a state where first data based on original data of display content is displayed; specify a difference between a region of the image where the display device is imaged and the original data; generate second data by correcting the first data in such a way as to eliminate the difference; and display the second data on the display device.

This application is based upon and claims the benefit of priority from Japanese Patent Application No. 2024-168031, filed on Sep. 27, 2024, the disclosure of which is incorporated herein in its entirety by reference.

### TECHNICAL FIELD

The present disclosure relates to a display correction apparatus, a display correction method, and a recording medium.

### BACKGROUND ART

In order to display various types of content such as advertisements or guide signs, there is a technology for displaying data indicating the content on a display device such as a liquid crystal display or an electronic paper.

In a case where data is displayed on the display device, there is a case where there is a difference between the data to be displayed and data actually displayed on the display device. To eliminate such a difference, the display may be adjusted.

JP 2018-054763 A describes a technique for causing another image projection apparatus to project an image for adjustment used for adjustment in multi-screen display performed using a plurality of image projection apparatuses.

### SUMMARY

An example of objects of the present disclosure is to facilitate bringing display using a display device closer to originally assumed display.

A display correction apparatus according to one aspect of the present disclosure includes image acquisition means for acquiring an image obtained by imaging a display device in a state where first data based on original data of display content is displayed, specification means for specifying a difference between a region of the image where the display device is imaged and the original data, correction means for generating second data by correcting the first data in such a way as to eliminate the difference, and display control means for displaying the second data on the display device.

A display correction method according to one aspect of the present disclosure includes acquiring an image obtained by imaging a display device in a state where first data based on original data of display content is displayed, specifying a difference between a region of the captured image where the display device is imaged and the original data, generating second data by correcting the first data in such a way as to eliminate the difference, and displaying the second data on the display device.

A program according to one aspect of the present disclosure causes a computer to execute processing including acquiring an image obtained by imaging a display device in a state where first data based on original data of display content is displayed, specifying a difference between a region of the captured image where the display device is imaged and the original data, generating second data by correcting the first data in such a way as to eliminate the difference, and displaying the second data on the display device.

Each program may be stored in a non-transitory computer-readable recording medium.

### BRIEF DESCRIPTION OF THE DRAWINGS

FIG. 1 is a diagram illustrating a configuration of a system including a display correction apparatus;

FIG. 2 is a block diagram illustrating a functional configuration of the display correction apparatus;

FIG. 3 is a diagram illustrating an example of display content;

FIG. 4 is a diagram illustrating an example of an image obtained by imaging a display device;

FIG. 5 is a diagram illustrating an example of the display content;

FIG. 6 is a diagram illustrating an example of the image obtained by imaging the display device;

FIG. 7 is a flowchart illustrating an operation of the display correction apparatus;

FIG. 8 is a block diagram illustrating another example of the functional configuration of the display correction apparatus; and

FIG. 9 is a diagram illustrating a hardware configuration in which the display correction apparatus according to the present disclosure is achieved by a computer and its peripheral devices.

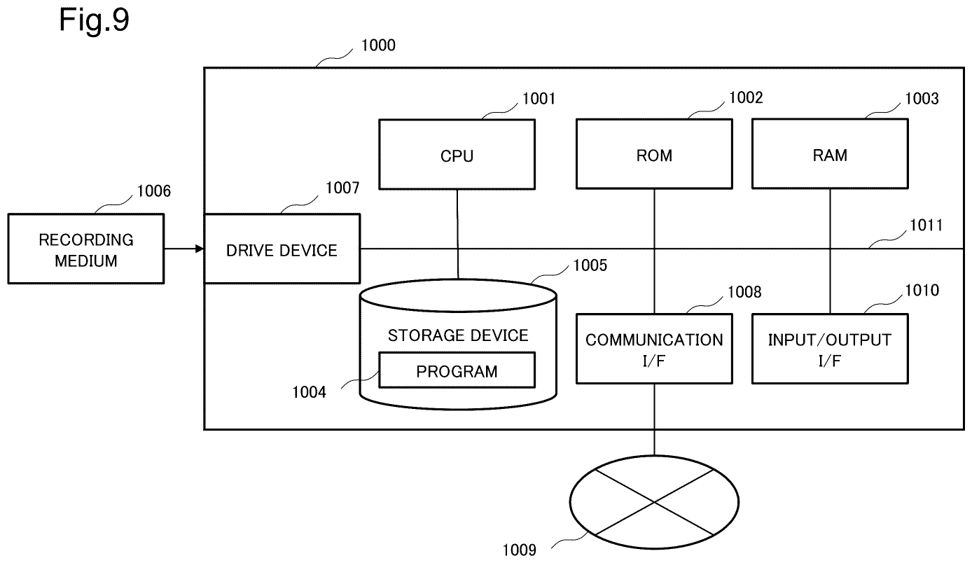

### EXAMPLE EMBODIMENT

Hereinafter, an example embodiment of the present disclosure will be described in detail with reference to the drawings.

### Example Embodiment

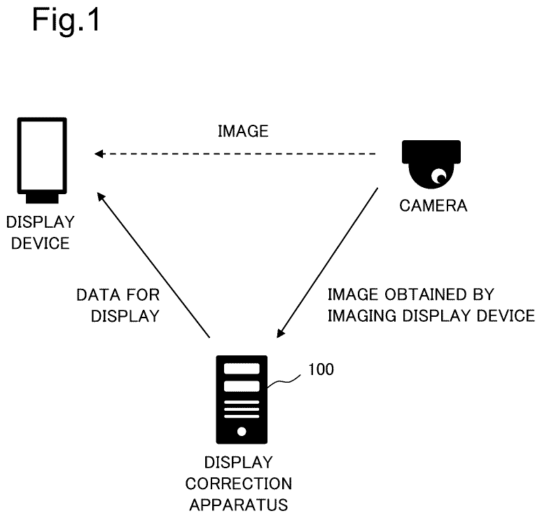

FIG. 1 is a diagram illustrating a configuration of a system including a display correction apparatus 100 according to the present disclosure.

In FIG. 1, the display correction apparatus 100 is an apparatus that corrects data in such a way as to bring display of a display device closer to originally assumed display. In FIG. 1, the display correction apparatus 100 is, for example, a server. The display correction apparatus 100 is communicably connected to the display device and a camera.

The display device is a display device that displays content. Here, although the content is an image that displays content of an advertisement or a guide sign, the content is not particularly limited. The display device is one or a plurality of display devices.

The display device displays one or a plurality of pieces of content. In the following description, a display device in a case where a plurality of display devices displays single content may be referred to as a multi-configuration display device.

The display device is, for example, an electronic paper, a liquid crystal display, an organic electro luminescence (EL) display, a projector, or the like.

In FIG. 1, the camera is a camera that images the display device in a state of displaying predetermined data. Imaging the display device is imaging a position projected by a projector, in a case where the display device is the projector.

The camera images the display device using one or a plurality of cameras. The camera may be a fixed camera such as a monitoring camera or may be a movable camera included in a terminal device, and is not particularly limited.

A configuration of a system including the display correction apparatus 100 is not limited to the example in FIG. 1. For example, the display correction apparatus 100 may be a terminal device such as a smartphone, a tablet terminal, or a PC. In this case, the camera may be a camera included in the terminal device.

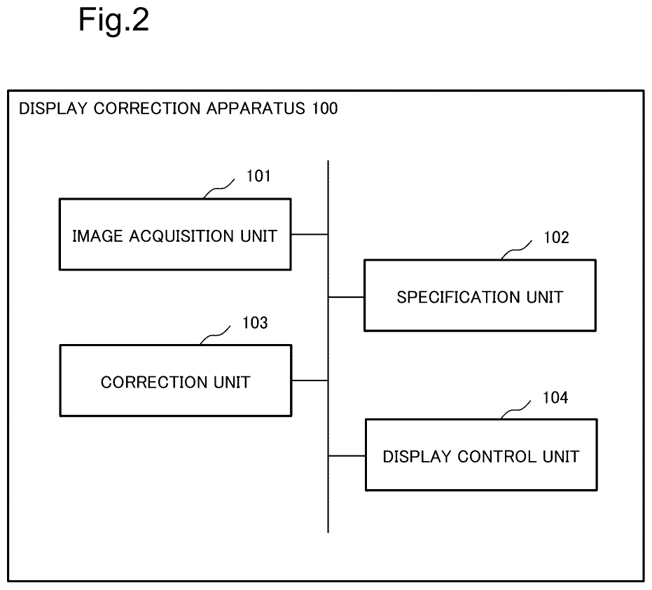

FIG. 2 is a block diagram illustrating a functional configuration of the display correction apparatus 100. Referring to FIG. 2, the display correction apparatus 100 includes an image acquisition unit 101, a specification unit 102, a correction unit 103, and a display control unit 104.

The image acquisition unit 101 is an example of image acquisition means for acquiring an image obtained by imaging the display device in a state where first data based on original data of display content is displayed. The image is an image captured by the camera described above.

The display content is content to be displayed on the display device. The first data may be data processed to display the original data on the display device or may be the original data itself. The processing for displaying the data on the display device may be, for example, adding trimming or a margin according to dimensions of a displayable region of the display device, changing a form of the data, or the like, and is not particularly limited.

The specification unit 102 is an example of specification means for specifying a difference between a region of the image where the display device is imaged and the original data. Here, the difference is, for example, a display deviation or a color difference. The original data may be acquired from the display device or a terminal device of a user who uses the display correction apparatus 100 at a timing when the image acquisition unit 101 acquires the image or may be stored in advance in a database communicably connected to the display correction apparatus 100.

The region of the image where the display device is imaged may be extracted from an image, for example, using a known technique by an extraction unit (not illustrated). The region of the image where the display device is imaged may be, for example, a display unit of the single display device. For example, in a case where the display device has the multi configuration, the region of the image where the display device is imaged may be an outer shape of a plurality of display units included in the multi-configuration display device. In this case, it is conceivable that a bezel of the display device, a gap between the display devices, or the like is included between the plurality of display units. That is, the outer shapes of the plurality of display units included in the multi-configuration display device include the bezel of the display device, the gap between the display devices, or the like.

It is conceivable that the region of the image where the display device is imaged is distorted due to a positional relationship between a direction in which the camera captures an image and a position of the display device. Therefore, the extraction unit may correct the distortion of the region or the image where the display device is imaged, using the known technique. At this time, the extraction unit may be provided inside or outside the display correction apparatus 100.

Next, a case will be described where the specification unit 102 specifies the display deviation. As the display deviation, the display device mainly assumes a display deviation in a case where the plurality of display devices displays the single display content.

In a case where a single piece of data is displayed using the plurality of display devices, for example, there is a case where a non-display region that is not displayed in display of single content is generated, due to the bezel of the display device, the gap between the display devices, or the like. In a case where the non-display region exists, in a case where the display content is displayed using the first data simply cut in such a way that the original data is displayed on each display unit of the display device, the display content may be extended. Therefore, the specification unit 102 specifies the display deviation caused by the non-display region, as the difference.

That is, the display deviation in this case is a display deviation caused by the non-display region that is not displayed, between the display units of the plurality of display devices. The non-display region is the bezel of the display device or the gap between the plurality of display devices.

An example of processing for specifying the display deviation caused by the non-display region, by the specification unit 102 will be described.

First, the specification unit 102 specifies whether the display is deviated, by comparing the region of the image where the display device is imaged and the difference from the original data. Here, the display deviation is a deviation of an object included in content or an extension of the object.

For example, the specification unit 102 specifies the object in the original data, by image recognition. For example, the object may be designated by an operation input by the user who uses the display correction apparatus 100, or the like. Then, the specification unit 102 specifies the object in the region of the image where the display device is imaged, and in a case where there is a shape difference between the object in the original data and the object in the region of the image where the display device is imaged, the specification unit 102 specifies that the display is deviated. The shape difference may be specified, for example, based on an outer shape of the object or an aspect ratio of the outer shape of the object, and in addition, a method for specifying the shape difference is not particularly limited.

Then, in a case where the display is deviated, the specification unit 102 specifies the non-display region, in the outer shapes of the display units of the plurality of display devices.

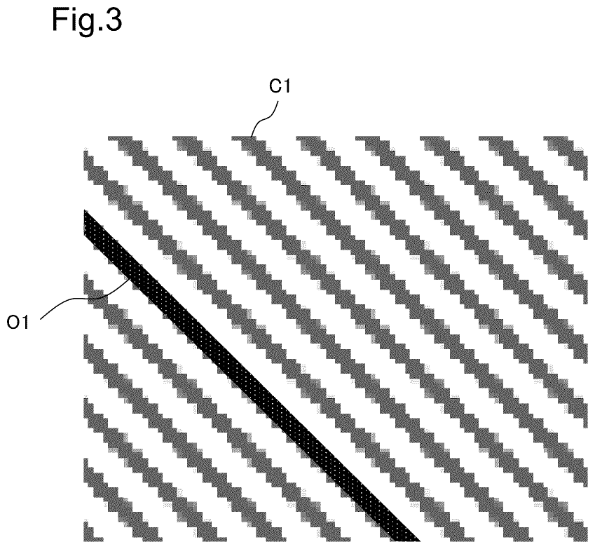

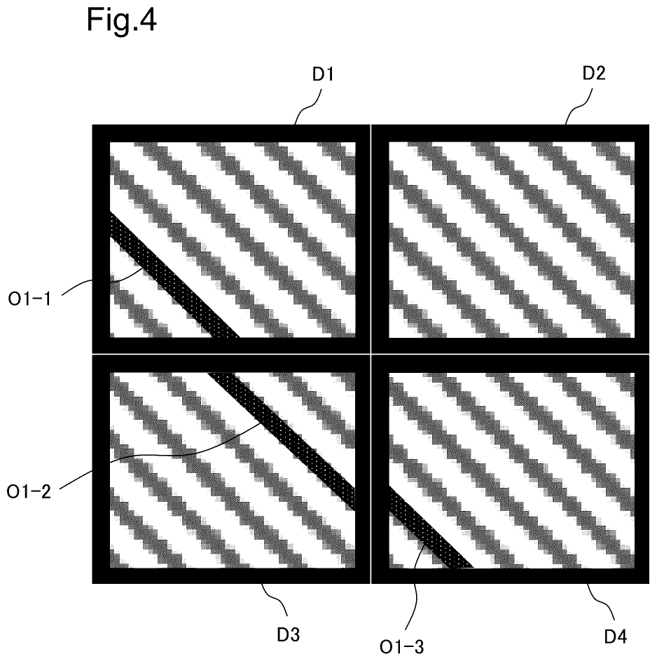

A specific example of the display deviation will be described with reference to FIGS. 3 and 4.

FIG. 3 is a diagram illustrating an example of the display content. Display content C1 illustrated in FIG. 3 is a pattern including a plurality of oblique lines. In FIG. 3, one of the plurality of oblique lines is referred to as an object O1.

FIG. 4 is an example of a state where multi-configuration display devices D1 to D4 display the display content C1 in FIG. 3. FIG. 4 is a state where the first data simply cut is displayed in such a way that original data of the display content C1 is displayed on each of display units of the display devices D1 to D4. In FIG. 4, the object O1 includes O1-1 displayed on the display device D1, O1-2 displayed on the display device D3, and O1-3 displayed on the display device D4.

As in FIG. 4, in a case where the first data simply cut is displayed in such a way that the original data of the display content C1 is displayed on each of the display units of the display devices D1 to D4, the object O1 that is originally connected is displayed in a deviated state. A deviation between O1-1 and O1-2 is caused by a bezel of the display device D1 and a bezel of the display device D3, which are the non-display regions. The same applies to a deviation between O1-2 and O1-3. Such a deviation may give a sense of discomfort, to a person who views the display content C1.

In this case, for example, the specification unit 102 may specify the display deviation, by comparing an outer shape of the object O1 in the original data and outer shapes of the objects O1-1, O1-2, and O1-3 in the region of the image where the display device is imaged. Then, the specification unit 102 specifies the non-display region, in the display devices D1 to D4 in the image.

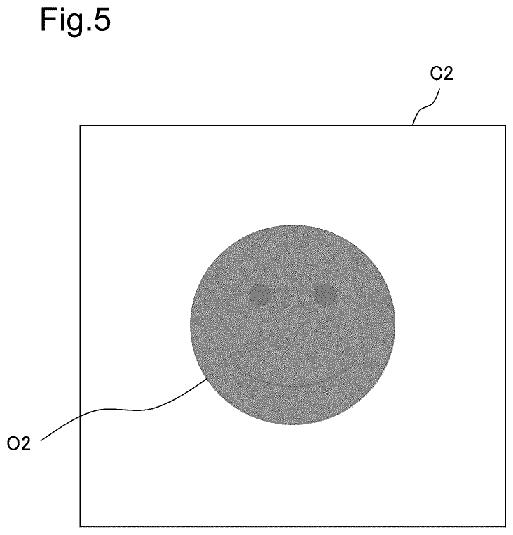

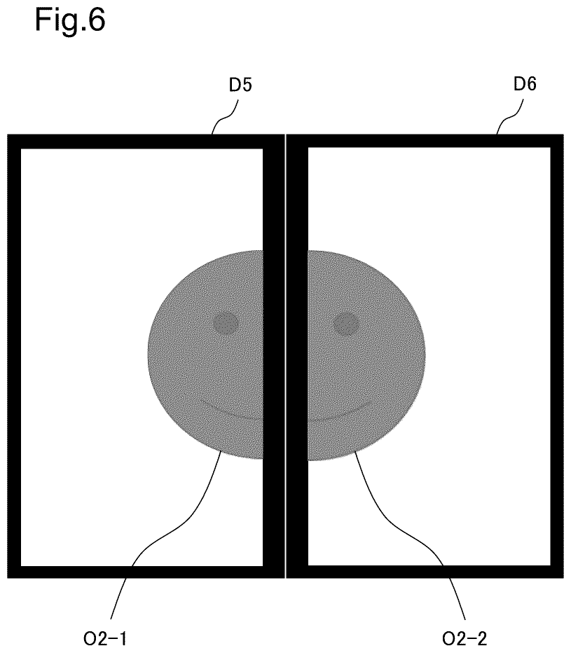

Another specific example of the display deviation will be described with reference to FIGS. 5 and 6.

FIG. 5 is a diagram illustrating an example of the display content. Display content C2 illustrated in FIG. 5 is an illustration in which two eyes and a mouth in a circle represent a smile. In FIG. 5, the illustration is referred to as an object O2.

FIG. 6 is an example of a state where multi-configuration display devices D5 and D6 display the display content C2 in FIG. 5. FIG. 6 is a state where the first data simply cut is displayed in such a way that original data of the display content C2 is displayed on each of display units of the display devices D5 and D6. In FIG. 6, the object O2 includes O2-1 displayed on the display device D5 and O2-2 displayed on the display device D6.

As in FIG. 6, in a case where the first data simply cut is displayed in such a way that original data of the display content C2 is displayed on each of the display units of the display devices D5 and D6, the object O2 is displayed in a laterally extended state. The extension of the object O2 is caused by a bezel of the display device D5 and a bezel of the display device D6 between O2-1 and O2-2, which are the non-display regions. Such an extension may give a sense of discomfort to a person who views the display content C2.

In this case, for example, the specification unit 102 may specify the display deviation, by comparing an outer shape or an aspect ratio of the object O2 in the original data and outer shapes or aspect ratios of the objects O2-1 and O2-2 in the region of the image where the display device is imaged. Then, the specification unit 102 specifies the non-display region, in the display devices D5 and D6 in the image.

The example of the display deviation and the method for specifying the display deviation are not limited to these examples. For example, overlapping of the display units of the display devices may cause the display deviation. In this case, the display deviation is a deviation caused by an overlapping region where the display units of the plurality of display devices overlap, and the specification unit 102 may specify the overlapping region.

Next, a case will be described where the specification unit 102 specifies a color difference. In a case where the specification unit 102 specifies the color difference, the number of display devices may be one or more and is not particularly limited.

The specification unit 102 specifies a color difference between a color of the region of the captured image where the display device is imaged and a color of the original data, as the difference. Although the specification unit 102 may specify the color difference, for example, in accordance with an RGB (Red, Green, Blue) value, a method for specifying the color difference is not limited to this example.

The specification unit 102 may specify the color difference between the color of the region of the captured image where the display device is imaged and the original data, in a predetermined region of the display content, as the color difference. The predetermined region may be entire display content or a part of the display content.

For example, the predetermined region is a region where the color difference should be eliminated. The region where the color difference should be eliminated is, for example, a region determined to be important in the display content. The region where the color difference should be eliminated may be set in advance by an operation input of the user who uses the display correction apparatus 100 or may be specified using a learned model that has learned a relationship between the display content and the region determined to be important in the display content. Processing for specifying the region determined to be important in the display content using the learned model may be executed by an important region specification unit provided inside or outside the display correction apparatus 100.

The region determined to be important in the display content may be, for example, a region of a most important object in the display content, a region with a color occupying a large region in the display content, or the like, but is not limited to these examples.

The correction unit 103 is an example of correction means for generating second data by correcting the first data in such a way as to eliminate the difference specified by the specification unit 102. The correction unit 103 may generate the second data by correcting the original data, instead of the first data. The first data may be acquired from the display device or a terminal device of the user who uses the display correction apparatus 100 at a timing when the image acquisition unit 101 acquires the image or may be stored in advance in a database communicably connected to the display correction apparatus 100.

The correction unit 103 generates the second data by a method according to a type of the difference.

First, an example of a method in which the correction unit 103 generates the second data in such a way as to eliminate the display deviation will be described.

For example, in the multi-configuration display device, in a case where the display is deviated due to the non-display region, the correction unit 103 enlarges the first data and generates the second data in which a region related to the non-display region is deleted from the enlarged first data. An order of enlargement and deletion processing is not particularly limited. The correction unit 103 associates the second data with arrangement information, using the arrangement information associated with the first data. The arrangement information is information regarding arrangement of the plurality of display devices included in the multi-configuration display device. The arrangement information includes, for example, identification information of each of the plurality of display devices included in the multi-configuration display device, and information indicating a dimension of the display device, the number of arranged display devices, an arrangement position, or the like. The arrangement information may be stored in advance in the database communicably connected to the display correction apparatus 100 or may be detected as described later.

In a case where a region related to the non-display region in the first data or the original data is a deletion prohibition region, the correction unit 103 enlarges or moves the first data or the original data, in such a way that the deletion prohibition region does not relate to the non-display region. Here, the deletion prohibition region is a region of the original data where deletion is prohibited. The deletion prohibition region may be, for example, an object such as an important character or illustration in the display content. Then, the correction unit 103 may generate the second data obtained by deleting the region related to the non-display region from the data obtained by enlarging or moving the first data or the original data.

For example, in the multi-configuration display device, in case where the display is deviated due to the overlapping region, the correction unit 103 reduces the first data, and generates the second data in which a region related to the overlapping region is duplicated from the first data or one of the regions related to the overlapping region is deleted.

The method for performing correction in such a way as to eliminate the display deviation by the correction unit 103 is not limited to these examples.

Next, an example of a method for generating the second data by the correction unit 103 in such a way as to eliminate the color difference will be described. For example, the correction unit 103 generates the second data obtained by correcting the RGB values, in such a way as to cancel the color difference specified by the specification unit 102, from the first data. For example, in a case where a difference in the R value of the region of the image where the display device is imaged with respect to the original data is −5, a difference in the G value is −10, and a difference in the B value is −7, the correction unit 103 corrects the R value of the first data or the original data to +5, the G value to +10, and the B value to a value of +7. The method for performing correction in such a way as to eliminate the color difference by the correction unit 103 is not limited to these examples.

In a case where the difference is equal to or less than a predetermined value, the correction unit 103 may determine not to perform correction. This is because there is a case where there is no problem even if a slight difference is not corrected or a case where a correctable range is limited according to characteristics of content to be displayed, a type of the display device, a performance of the display device, a display environment, or the like. The predetermined value serves as a reference for determination to perform correction. The predetermined value may be different for each display content, may be different according to the type of the display device or the performance of the display device, or may be constant. The predetermined value may be designated by an operation input of the user who uses the display correction apparatus 100 or may be determined using a learned model that has learned a relationship between at least one of the display content, the type of the display device, and the performance of the display device and the predetermined value.

A degree of the correction performed by the correction unit 103 is not necessarily perfect and may be appropriately set. This is because there is a case where there is no problem even if a slight difference remains or a case where the correctable range is limited according to the characteristics of the content to be displayed, the type of the display device, the performance of the display device, the display environment, or the like. The degree of the correction may be determined according to the characteristics of the content to be displayed, the type of the display device, the performance of the display device, the display environment, or the like or may be designated by the operation input of the user who uses the display correction apparatus 100.

The correction unit 103 may execute both of the correction of the display deviation and the correction of the color difference or may execute only one of them. In a case where the correction unit 103 executes both of the correction of the display deviation and the correction of the color difference, an order of the two types of correction is not particularly limited.

The display control unit 104 is an example of display control means for displaying the second data on the display device. The display control unit 104 may directly control the display device or may indirectly control the display device by instructing a control unit of the display device to perform display.

In a case where the display device has a multi configuration, the display control unit 104 may display the second data on each of the plurality of display devices included in the multi configuration, using the arrangement information associated with the second data.

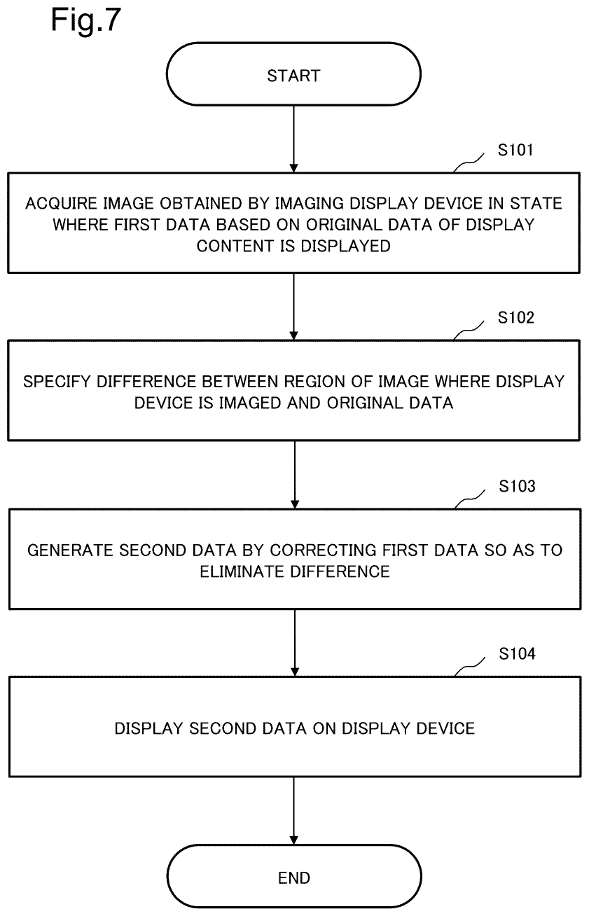

An operation of the display correction apparatus 100 configured as described above will be described with reference to the flowchart in FIG. 7.

First, the image acquisition unit 101 acquires an image obtained by imaging the display device in a state where the first data based on the original data of the display content is displayed (step S101).

Next, the specification unit 102 specifies the difference between the region of the image acquired in step S101 where the display device is imaged and the original data (step S102).

Next, the correction unit 103 generates the second data by correcting the first data in such a way as to eliminate the difference specified in step S102 (step S103).

Then, the display control unit 104 displays the second data on the display device (step S104).

As described above, the display correction apparatus 100 ends the series of operations.

After the display control processing in step S104, the display correction apparatus 100 may further return to step S101 and repeat the series of operations of the display correction.

The display correction apparatus 100 may start the series of operations by an operation input of the user who uses the display correction apparatus 100 or may start the series of operations at a timing when display correction should be performed. The timing when the display correction should be performed may be a timing when at least one of the display device, the surrounding environment of the display device, and the display content has changed.

The display correction apparatus according to the present example embodiment described above includes the image acquisition unit, the specification unit, the correction unit, and the display control unit. The image acquisition unit acquires the image obtained by imaging the display device in a state where the first data based on the original data of the display content is displayed. The specification unit specifies the difference between the region of the image where the display device is imaged and the original data. The correction unit generates the second data by correcting the first data in such a way as to eliminate the difference. The display control unit displays the second data on the display device.

The display correction apparatus according to the present example embodiment corrects and displays the data to be displayed, using an image that actually displays the display content. As a result, the display correction apparatus according to the present example embodiment can facilitate bringing the display using the display device closer to the originally assumed display.

For example, since the display correction apparatus according to the present example embodiment corrects the data to be displayed without setting the display device, it is not necessary to adjust the setting in the display device or adjust a setting position or the like of the display device, and there is a case where it is easy to introduce the display correction apparatus into an existing display system.

For example, since the display correction apparatus according to the present example embodiment corrects the data of the display content that is actually displayed, fine correction, complicated correction, or the like can be performed for each display content, and correction may be appropriately performed.

### Modifications

Next, a modification of the present disclosure will be described in detail with reference to the drawings. Hereinafter, the description of content overlapping with the above description will be omitted to the extent that description of the present modification is not unclear.

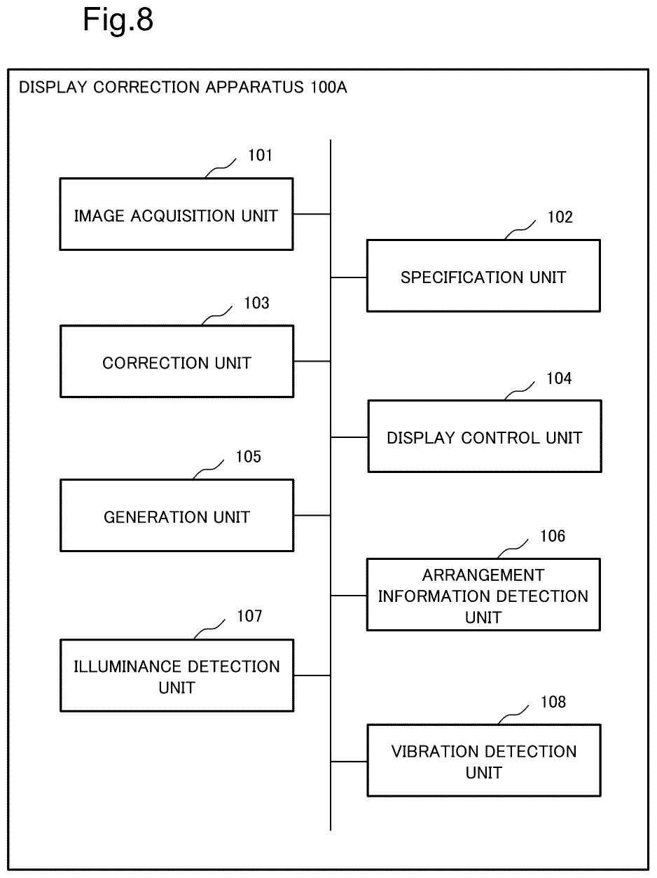

FIG. 8 is a block diagram illustrating a configuration of a display correction apparatus 100A. In FIG. 8, the display correction apparatus 100A includes a generation unit 105, an arrangement information detection unit 106, an illuminance detection unit 107, and a vibration detection unit 108, in addition to the configuration of the display correction apparatus 100.

The generation unit 105 is an example of generation means for generating a display template for display on a display device in such a way as to eliminate a difference. The display template is information indicating processing content of correction for correcting the first data in such a way as to eliminate the difference. The processing content of the correction may be the method described for the correction unit 103 in the example embodiment or a known method. The generation unit 105 stores display device identification information used to identify a display device that is a target for which the display template is generated, in a database (not illustrated), in association. The generation unit 105 may generate the display template using the method described for the correction unit 103 in the example embodiment or the known method, based on the difference specified by the specification unit 102. In this case, the correction unit 103 generates the second data by correcting the first data, based on the display template.

After the correction unit 103 performs correction, the generation unit 105 may generate the processing content of the correction by the correction unit 103, as the display template, for next or subsequent correction. In this case, in a case where there is a display template for the display device acquired by the image acquisition unit 101, the correction unit 103 generates the second data by correcting the first data, based on the display template.

The generation unit 105 may associate a use condition of the display template, with the display template. The use condition of the display template may be an expiration date, an available environment, characteristics of available display content, or the like. The expiration date of the display template may be, for example, a period during which environment regarding display of the display device is not expected to change.

The arrangement information detection unit 106 is an example of arrangement information detection means for detecting the arrangement information of the display device. In a case where the display correction apparatus 100A includes the arrangement information detection unit 106, the user does not need to input the arrangement information in advance. For example, the arrangement information detection unit 106 detects the arrangement information, by detecting which data is imaged on which display device, from an image obtained by imaging the display device in a state where data for arrangement information detection is displayed. The data for arrangement information detection is, for example, a pattern in which various numbers are arranged, or the like. A method for detecting the arrangement information and the data for arrangement information detection are not limited to this example, and a known method may be used.

The illuminance detection unit 107 is an example of illuminance detection means for detecting an illuminance of the display device. For example, the illuminance detection unit 107 is installed around the display device and detects an illuminance, using a sensor that detects the illuminance of the display device. For example, in a case where the display device is installed outdoors, the illuminance detection unit 107 may detect the illuminance based on weather information.

In a case where the illuminance has changed, the image acquisition unit 101 may acquire the image obtained by imaging the display device. This is because a color of the display content displayed on the display device may look different due to the change in the illuminance. For example, in a case where the display device is an electronic paper, how the color looks changes depending on the illuminance. Therefore, in a case where the illuminance has changed, the display correction apparatus 100A can display the display content in a state close to an assumed state, by performing the series of operations of the display correction.

The vibration detection unit 108 is an example of vibration detection means for detecting vibration of the display device. For example, the vibration detection unit 108 is installed around the display device and detects vibration, using a sensor that detects the vibration of the display device.

In a case where the display device has vibrated, the image acquisition unit 101 may acquire the image obtained by imaging the display device. This is because the display device may move or tilt due to vibration and may be displaced. For example, in a case where the display device has a multi configuration, there is a case where the gap between the display devices changes due to the vibration. Therefore, in a case where the display device has vibrated, the display correction apparatus 100A can display the display content in the state close to the assumed state, by performing the series of operations of the display correction.

The display correction apparatus 100 may be changed to have a configuration including at least one of the generation unit 105, the arrangement information detection unit 106, the illuminance detection unit 107, and the vibration detection unit 108, described in the modification.

It is not easy for a person to adjust display due to a difference in sense or experience of each person.

An example of an effect of the present disclosure is to facilitate bringing display using a display device close to originally assumed display.

### Hardware Configuration

Some or all of the components of each device or system in each example embodiment of the present disclosure described above are achieved by, for example, any combination of an information processing apparatus 1000 and a program as illustrated in FIG. 15. As an example, the information processing apparatus 1000 includes the following components.
A Central Processing Unit (CPU) 1001
A Read Only Memory (ROM) 1002
A Random Access Memory (RAM) 1003
A program 1004 loaded into the RAM 1003
A storage device 1005 storing the program 1004
A drive device 1007 for reading/writing a recording medium 1006
A communication I/F 1008 connected to a communication network 1009
An input/output I/F 1010 for inputting/outputting data
A bus 1011 connecting each component
I/F is an abbreviation of Interface.

Each component of each apparatus or system in each example embodiment is achieved by the CPU 1001 acquiring and executing a program for achieving these functions. The program for achieving the function of each component of each apparatus is stored in the storage device 1005 or the RAM 1003 in advance, for example, and is read by the CPU 1001 as necessary. The program 1004 may be supplied to the CPU 1001 via a communication network, or may be stored in advance in the recording medium 1006, and the drive device 1007 may read the program and supply the program to the CPU 1001.

There are various modifications of the method for achieving each apparatus. For example, each apparatus or system may be achieved by any combination of the information processing apparatus 1000 and the program separate for each component. A plurality of components included in each apparatus may be achieved by any combination of one information processing apparatus 1000 and the program.

Some or all of the components of each apparatus or system are achieved by a general-purpose or dedicated circuitry including a processor or the like, or a combination thereof. The circuitry is, for example, a CPU, a Graphics Processing Unit (GPU), a Field Programmable Gate Array (FPGA), or a Large Scale Integration (LSI) for Artificial Intelligence (AI) processing. These may be configured by a single chip or may be configured by a plurality of chips connected via a bus. Some or all of the components of each apparatus may be achieved by a combination of the above-described circuitry and the like and the program.

In a case where some or all of the components of each apparatus or system are achieved by a plurality of the information processing apparatuses, circuitry, and the like, the plurality of information processing apparatuses, circuitry, and the like may be arranged in a centralized manner or in a distributed manner. For example, each of the information processing apparatuses, circuitry, or the like may be achieved in the form of a client server system, a cloud computing system, or the like in which they are connected to each other through a communication network.

While the present disclosure has been particularly shown and described with reference to each of the example embodiments thereof, the present disclosure is not limited to these example embodiments. It will be understood by those of ordinary skill in the art that various changes in form and details may be made therein without departing from the spirit and scope of the present disclosure as defined by the claims.

Although a plurality of operations is described in order in the form of a flowchart, the order of description does not limit the order of executing the plurality of operations. Therefore, in a case where each example embodiment is implemented, the order of the plurality of operations may be changed within a range that does not interfere with the content.

Some or all of the above example embodiments may be described as the following Supplementary Notes, but are not limited to the following.

### Supplementary Note 1

A display correction apparatus including:
image acquisition means for acquiring an image obtained by imaging a display device in a state where first data based on original data of display content is displayed;
specification means for specifying a difference between a region of the image where the display device is imaged and the original data;
correction means for generating second data by correcting the first data in such a way as to eliminate the difference; and
display control means for displaying the second data on the display device.

### Supplementary Note 2

The display correction apparatus according to supplementary note 1, further including:
generation means for generating a display template for causing the display device to perform display in such a way as to eliminate the difference, in which
the correction means generates the second data by correcting the first data, based on the display template.

### Supplementary Note 3

The display correction apparatus according to supplementary note 1 or 2, in which
the display device is formed to display single display content by a plurality of
the display devices, and
the specification means specifies a display deviation, as the difference.

### Supplementary Note 4

The display correction apparatus according to supplementary note 3, in which
the display deviation is a display deviation caused by a non-display region that is not displayed, between display units of the plurality of display devices.

### Supplementary Note 5

The display correction apparatus according to supplementary note 4, in which
the non-display region is a bezel of the display device.

### Supplementary Note 6

The display correction apparatus according to supplementary note 4 or 5, in which
the non-display region is a gap between the plurality of display devices.

### Supplementary Note 7

The display correction apparatus according to any one of supplementary notes 3 to 6, in which
the correction means generates the second data in which a region related to the non-display region is deleted from the first data.

### Supplementary Note 8

The display correction apparatus according to any one of supplementary notes 3 to 7, in which
the display deviation is an overlapping region where the display units of the plurality of display devices overlap.

### Supplementary Note 9

The display correction apparatus according to any one of supplementary notes 3 to 8, further including:
arrangement information detection means for detecting arrangement information of the display device, in which
the correction means generates the second data further using the arrangement information.

### Supplementary Note 10

The display correction apparatus according to any one of supplementary notes 1 to 9, in which
the specification means specifies a color difference between a color of a region of the captured image where the display device is imaged and the original data, as the difference.

### Supplementary Note 11

The display correction apparatus according to supplementary note 10, in which
the correction means generates the second data on which correction for reducing the color difference from the first data has been performed.

### Supplementary Note 12

The display correction apparatus according to supplementary note 10 or 11, in which
the specification means specifies a color difference between the color of the region of the captured image where the display device is imaged and the original data, in a predetermined region of the display content, as the color difference.

### Supplementary Note 13

The display correction apparatus according to supplementary note 12, in which
the predetermined region is a region determined to be important in the display content.

### Supplementary Note 14

The display correction apparatus according to any one of supplementary notes 10 to 13, further including:
illuminance detection means for detecting an illuminance of the display device, in which
the acquisition means acquires the image, in a case where a change in the illuminance is detected.

### Supplementary Note 15

The display correction apparatus according to any one of supplementary notes 1 to 14, in which
in a case where the difference is equal to or less than a predetermined value, the correction means determines not to perform correction.

### Supplementary Note 16

The display correction apparatus according to any one of supplementary notes 1 to 15, further including:
vibration detection means for detecting vibration of the display device, in which
in a case where the vibration is detected, the acquisition means acquires the image.

### Supplementary Note 17

A display correction method including:
acquiring an image obtained by imaging a display device in a state where first data based on original data of display content is displayed;
specifying a difference between a region of the captured image where the display device is imaged and the original data;
generating second data by correcting the first data in such a way as to eliminate the specified difference, based on the difference between the region of the captured image where the display device is imaged and the original data; and
displaying the second data on the display device.

### Supplementary Note 18

A program for causing a computer to execute processing including:
acquiring an image obtained by imaging a display device in a state where first data based on original data of display content is displayed;
specifying a difference between a region of the captured image where the display device is imaged and the original data;
generating second data by correcting the first data in such a way as to eliminate the specified difference, based on the difference between the region of the captured image where the display device is imaged and the original data; and
displaying the second data on the display device.

Some or all of the configurations described in Supplementary Notes 2 to 16 dependent on Supplementary Note 1 described above (display correction apparatus) can also be dependent on Supplementary Note 17 (display correction method) and Supplementary Note 18 (program) by the same dependency relationship as Supplementary Notes 2 to 16. Moreover, some or all of the configurations described as the Supplementary Notes can be similarly dependent on not only the Supplementary Notes 1, 17, and 18, but also various pieces of hardware and software, and various recording means or systems for recording software, without departing from the above-described example embodiments.

1. A display correction apparatus comprising:
one or more memories storing instructions; and
one or more processors configured to execute the instructions to:
acquire an image obtained by imaging a display device in a state where first data based on original data of display content is displayed;
specify a difference between a region of the image where the display device is imaged and the original data;
generate second data by correcting the first data in such a way as to eliminate the difference; and
display the second data on the display device.

2. The display correction apparatus according to claim 1, wherein the one or more processors are further configured to execute the instructions to:
generate a display template for causing the display device to perform display in such a way as to eliminate the difference; and
generate the second data by correcting the first data, based on the display template.

3. The display correction apparatus according to claim 1, wherein
the display device is formed to display single display content by a plurality of the display devices, and
the one or more processors are configured to execute the instructions to:
specify a display deviation, as the difference.

4. The display correction apparatus according to claim 3, wherein
the display deviation is a display deviation caused by a non-display region that is not displayed, between display units of the plurality of display devices.

5. The display correction apparatus according to claim 4, wherein
the non-display region is at least one of a bezel of the display device and a gap between the plurality of display devices.

6. The display correction apparatus according to claim 4, wherein the non-display region is a gap between the plurality of display devices.

7. The display correction apparatus according to claim 3, wherein the one or more processors are configured to execute the instructions to:
generate the second data in which a region related to the non-display region is deleted from the first data.

8. The display correction apparatus according to claim 3, wherein
the display deviation is an overlapping region where the display units of the plurality of display devices overlap.

9. The display correction apparatus according to claim 3, wherein the one or more processors are further configured to execute the instructions to:
detect arrangement information of the display device; and
generate the second data further using the arrangement information.

10. The display correction apparatus according to claim 1, wherein the one or more processors are further configured to execute the instructions to:
specify a color difference between a color of a region of the captured image where the display device is imaged and the original data, as the difference.

11. The display correction apparatus according to claim 10, wherein the one or more processors are further configured to execute the instructions to:
generate the second data on which correction for reducing the color difference from the first data has been performed.

12. The display correction apparatus according to claim 10, wherein the one or more processors are configured to execute the instructions to:
specify a color difference between the color of the region of the captured image where the display device is imaged and the original data, in a predetermined region of the display content, as the color difference.

13. The display correction apparatus according to claim 12, wherein
the predetermined region is a region determined to be important in the display content.

14. The display correction apparatus according to claim 10, wherein the one or more processors are further configured to execute the instructions to:
detect an illuminance of the display device; and
acquire the image, in a case where a change in the illuminance is detected.

15. The display correction apparatus according to claim 1, wherein the one or more processors are configured to execute the instructions to:
in a case where the difference is equal to or less than a predetermined value, determine not to perform correction.

16. The display correction apparatus according to claim 1, wherein the one or more processors are further configured to execute the instructions to:
detect vibration of the display device; and
in a case where the vibration is detected, acquire the image.

17. A display correction method comprising:
acquiring an image obtained by imaging a display device in a state where first data based on original data of display content is displayed;
specifying a difference between a region of the captured image where the display device is imaged and the original data;
generating second data by correcting the first data in such a way as to eliminate the difference; and
displaying the second data on the display device.

18. A non-transitory recording medium storing program for causing a computer to execute processing comprising:
acquiring an image obtained by imaging a display device in a state where first data based on original data of display content is displayed;
specifying a difference between a region of the captured image where the display device is imaged and the original data;
generating second data by correcting the first data in such a way as to eliminate the difference; and
displaying the second data on the display device.
